(19) United States
(12) Patent Application Publication
(10) Pub. No.: US 2006/0018117 A1
(43) Pub. Date: Jan. 26, 2006

(54) Structure for adding color lights to mobile phones

(75) Inventors: Cheng-Shing Lai, Taipei Hsien (TW); Hua Lin, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/893,957

(22) Filed: Jul. 20, 2004

(51) Int. Cl. F21V 33/00

(52) U.S. Cl. 362/231; 362/253

(57) ABSTRACT

The present invention is to provide a structure for adding color lights to a mobile phone with low incurred cost, which comprises a light red, a light green, and a light blue circuits being connected in parallel to a red, a green and a blue circuits respectively in a mobile phone for enabling at least a red, a green and a blue light emitting diodes to emit a light red, a light green and a light blue rays; a plurality of current limit resistors being respectively installed within said circuits for regulating the magnitude of currents therethrough to said light emitting diodes; thereby a central processor controls said currents provided to said light emitting diodes for selectively emitting said red, green, blue, light red, light green and light blue rays to produce various combinations of color rays.

### FIELD OF THE INVENTION

The present invention relates to a structure for adding color lights to mobile phones, more particularly to a structure for increasing color lights from the original seven color lights to sixteen color lights to mobile phones with a low incurred cost.

### BACKGROUND OF THE INVENTION

With the fast development of science and technology, mobile phones become very popular, and almost everyone has a mobile phone these days. Since our life has entered into a new era with booming telecommunication technologies, mobile phones have brought a hot wave to the telecommunication industry in recent years. In early nineties, there were only about 1,000 mobile telecommunication users in the world; and a decade after, there are over 3.5 hundred million users now. The statistical data of the International Telecommunication Union (ITU) forecasted that there would be 5 hundred million mobile telecommunication users by the end of 2003, which is about half of the quantity of the traditional city phones (9.5 hundred millions) by that time. For a conservative estimate, the number of mobile phones will go far beyond the number of city phone users after 2005, and the mobile phone will become a mainstream of telecommunications. Cellular mobile phone telecommunication is a revolutionary change to the telephone technology, which is no longer a node-to-node call, but is a person-to-person telecommunication. In addition, since the mobile phone is light and handy, easy-to-carry, reasonably priced, and capable of roaming over a network, mobile telecommunication become less restricted by time and space, and everyone can use it anywhere anytime. Therefore, mobile phones become a necessity of our telecommunications.

As the development of mobile phones proceeds up to now, it evolves from the original medium for transmitting voices to the present device concurrently having the function of transmitting information. As to the types of data transmission, the first-generation mobile phones generally use an analog specification for the transmission, and the content of transmission is primarily voices. Both confidentiality and transparency are not as good. The second-generation mobile phones generally use a digital specification for the transmission. After a voice is digitized and coded, the digital codes are transmitted through packets, which greatly enhances the confidentially. However, with the arrival of the network era, the demand for digital webs and wireless webs is increasing, and mobile phones have been specified as an important integrated, controlled communication unit among independent products in the information appliance area. Till then, the demand for the data transmission of mobile phones greatly increases, and only the transmission and processing of the voice were taken into consideration at the early stage of establishing the second-generation mobile phone specification, but the data volume of pure digitized voice is not large. The transmission rate of 9.6 Kbps is sufficient for the second-generation mobile phones, but if it needs to process data including images and files, then the transmission rate of the second-generation mobile phone is insufficient. Therefore, the specifications for the second and half generation and the third generation were developed to cope with the huge data volume in the network era. The present transmission rate of the 2.5th generation specification reaches 115 kbps. With a great improvement on transmission rate, the requirement of transmission rate for static screens can be fulfilled, and the objective for the wireless web under the established 2.5th generation transmission specification can be achieved finally. The establishment of the third-generation specification further raises the transmission rate to 2.4 Mbps, so that the transmission of dynamic images can be implemented on a mobile phone. After the era of 3G has arrived, we can even watch televisions and movies or conduct person-to-person video conferencing through a mobile phone. The era of 3G will make our life more convenient, the access of information more timely, and the integration of communication, information, and network more closely. The structure of a mobile phone is divided into hardware and software, and the hardware is further divided into a base module, an intermediate frequency module, a radio frequency module, and other components. The radio frequency module comprises a power amplifier (PA), a transmission receiver and a synthesizer; the intermediate frequency has an AD or DA signal converter; and the base module comprises a digital signal processor (DSP), a microcontroller (MCU) and a memory. Other components include a housing, a liquid crystal display (LCD), a printed circuit board (PCB), an antenna, a keypad, a speaker, a microphone, a subscriber identity module (SIM) and a battery.

At present, only seven color lights can be produced by various mobile phones, and its main structure uses a light emitting diode assembly which includes a light emitting diode having three circuits: a red circuit, a green circuit and a blue circuit. One end of the light emitting diode assembly is a common anode or a common cathode, and the other end respectively uses an over current limit resistor, a transistor and an I/O port of a central processing unit (CPU) to work together with a driver program to control the electric connection of one of the red, green and blue circuits to produce seven color rays: green, blue, yellow (red+green), teal (green+blue), purple (red+blue) and white (red+blue+green).

### SUMMARY OF THE INVENTION

With the previous profound introduction of the prior art, it is not difficult for us to see that general mobile phones can only show seven color lights at the time being. Therefore, the inventor of the present invention based on the present development trend of the information technology to conduct extensive researches and experiments, and finally invented a structure of adding color lights to mobile phones with low incurred cost. Such ingenious idea of the invention is definitely a great contribution to the extensive consumers.

The primary objective of the invention focuses on the foregoing deficiency to design a structure for adding different color lights by regulating the magnitude of the currents to determine the brightness of the corresponding light emitting diodes. Three circuits such as a light red circuit, a light green circuit and a light blue circuit are connected in parallel to the original three circuits such as a red circuit, a green circuit and a blue circuit built in the mobile phone. At least one limit current resistor installed in each circuit is used to regulate the magnitude of the current passing therethrough, so that the light emitting diodes produce a light red, a light green and a light blue rays in addition to a red, a green and a blue rays. Further, a central processor is used to control the currents provided to the light emitting diodes for selectively emitting the red, green, blue, light red, light green and light blue rays to produce various combinations of color rays.

The above and other objects, features and advantages of the present invention will become apparent from the following detailed description taken with the accompanying drawings.

### BRIEF DESCRIPTION OF THE DRAWINGS

FIG. 1 is a schematic circuit diagram of the present invention.

### DETAILED DESCRIPTION OF THE PREFERRED EMBODIMENTS

The present invention discloses a structure for adding color lights to mobile phones with low incurred cost, and such structure uses additional circuits to regulate the magnitude of the currents to determine the brightness of corresponding light emitting diodes. Three circuits such as a light red circuit, a light green circuit and a light blue circuit are connected in parallel to the original three circuits such as a red circuit, a green circuit and a blue circuit built in the mobile phone. At least one limit current resistor installed in each circuit is used to regulate the magnitude of the current passing therethrough, so that the light emitting diodes produce a light red, a light green and a light blue rays in addition to a red, a green and a blue rays. Further, a central processor is used to control the currents provided to the light emitting diodes for selectively emitting the red, green, blue, light red, light green and light blue rays to produce various combinations of color rays.

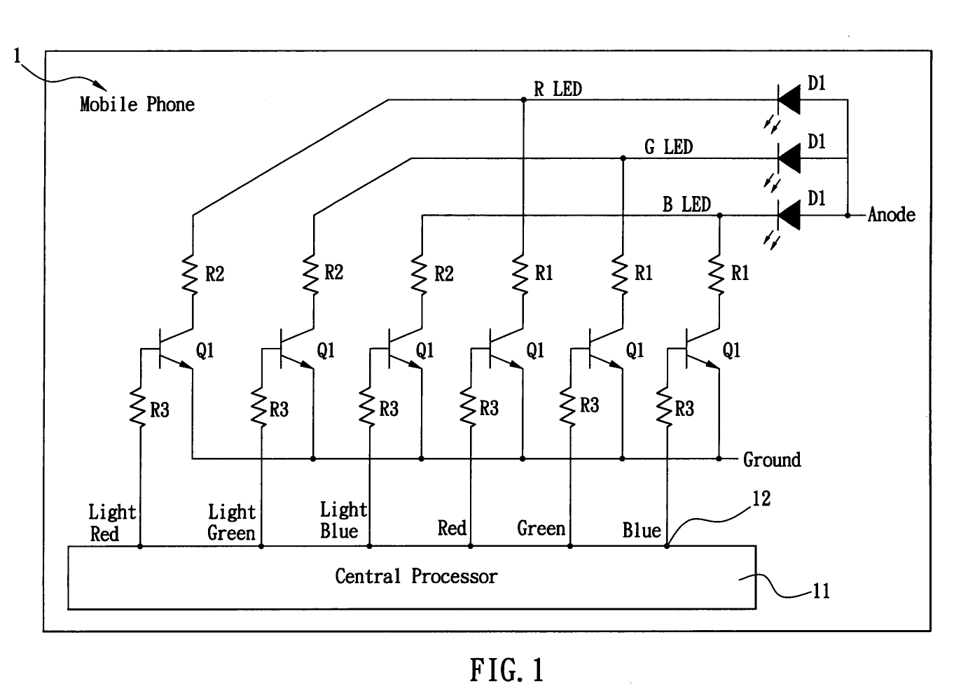

Please refer to FIG. 1 for a mobile phone 1 according to the invention comprises three light emitting diodes D1 having a common anode, and these light emitting diodes are a red LED, a green LED and a blue LED; a first current limit resistor R1 individually coupled to each of said light emitting diodes D1 for controlling and maximizing the brightness of the lights emitted; a transistor Q1 individually coupled to each of a first current limit resistor R1 and having a function equivalent to a switch, and its remitter being grounded, and its base passing through a third current limit resistor R3 (preferably equal to or larger than 10K) and being coupled to an I/O port 12 of the central processing unit (CPU) 11, and a high potential or a low potential of the CPU is used to control to turn of a light. For example, if it is necessary to show a green light, then the CPU sets the electric potential of the I/O port coupled to the green circuit to low as to electrically connect the transistor Q1 and the green LED for producing the green light. Similarly, if it is necessary to show a purple light, which is a combination of a red LED and a blue LED, the electric potential of the I/O ports coupled to the red LED and the blue LED circuits are set to low simultaneously.

In addition, the present invention also comprises a second current limit resistor R2 coupled to each of said light emitting diodes D1 for controlling the brightness of the lights and producing a light with a lower brightness; wherein the resistance of the second current limit resistor R2 is larger than that of the first current limit resistor R1. The present invention further comprises a transistor Q1 coupled to each of the second current limit resistors R2 and having a function equivalent to a switch, with its transmitter being grounded and its base passing through a third current limit resistor R3 (preferably equal to or larger than 10K) and being coupled to an I/O port I2 of the central processing unit (CPU) I1. The high potential or low potential of the CPU is used to control and turn on an LED.

Since the brightness of an LED relates to the magnitude of a current passing through the LED, therefore if the current is large, then the LED is brighter. In other words, if the magnitude of the parallel current limit resistors is controlled under the same voltage, then the brightness of the LED can be controlled. The larger the resistance of the current limit resistor, the dimmer is the LED. Since the resistance of the second current limit resistor R2 is larger than the resistance of the first current limit resistor R1, therefore the brightness of the LED coupled to the second current limit resistor R2 is dimmer than the brightness of the LED coupled to the first current limit resistor R1, and thus showing a light red, a light green and a light blue lights.

If a driver program is used to control the electrical connection of one or several circuits, then more color lights can be produced. The related combinations of color lights are listed below:

(1) Seven color lights are shown by the previous three circuits: red circuit, green circuit and blue circuit:

Green+Blue=Teal;

Red+Green=Yellow;

Blue+Red=Purple;

Red+Green+Blue=White;

(2) Since three circuits including the light red circuit, the light green circuit and the light blue circuit are added, therefore more choices of combinations are provided to produce more color lights.

Blue+Light Green=Sky Blue;

Red+Light Green=Orange;

Red+Light Blue=Pink;

Green+Light Red=Yellowish Green;

Blue+Light Red=Bluish Purple

Therefore, more color rays are added. As to the combinations Red+Sky Blue, Blue+Yellowish Green, and Green+Bluish Purple, etc are not significant among the present three color LEDs. However, a better effect can be accomplished if better workmanship is given to the light emitting diodes D1.

While the invention has been described by means of specific embodiments, numerous modifications and variations could be made thereto by those skilled in the art without departing from the scope and spirit of the invention set forth in the claims.

What is claimed is:

1. A structure for adding color lights to mobile phones, comprising:
a red, a green, and a blue circuits having at least a red, a green, and a blue light emitting diodes respectively in a mobile phone for emitting a red, a green, and a blue rays;
a light red, a light green, and a light blue circuits being connected in parallel to said red, said green, and said blue circuits respectively for enabling said red, said green, and said blue light emitting diodes to emit a light red, a light green and a light blue rays;
a plurality of current limit resistors being respectively installed within said circuits for regulating the magnitude of currents therethrough to said light emitting diodes;
thereby a central processor controls said currents provided to said light emitting diodes for selectively emitting said red, green, blue, light red, light green and light blue rays to produce various combinations of color rays.

2. The structure of claim 1, wherein said light emitting diodes having a common anode.

3. The structure of claim 2, wherein said current limit resistors individually coupled to said light emitting diodes for controlling the brightness of said color rays.

4. The structure of claim 3, wherein each of said circuits further comprising a transistor being coupled individually to said current limit resistor and having a function equivalent to a switch, wherein an emitter of said transistor is grounded and a base of said transistor is connected to said central processor through another current limit resistor.

5. The structure of claim 4, wherein said another current limit resistors installed in said red, green and blue circuits respectively have a resistance larger than the resistance of said another current limit resistors installed in said light red, light green and light blue circuits.
